(19) United States
(12) Patent Application Publication
(10) Pub. No.: US 2008/0265537 A1
(43) Pub. Date: Oct. 30, 2008

(54) Wheelbarrow with tiltable container

(75) Inventor: Paul Lin, Tainan Hsien (TW)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Macauto Industrial Co., Ltd., Yung-Kang City (TW)

(21) Appl. No.: 11/796,435

(22) Filed: Apr. 26, 2007

(51) Int. Cl. B62B 1/24

(52) U.S. Cl. 280/47.31

(57) ABSTRACT

A wheelbarrow includes a wheelbarrow frame, a wheel, a bracket, and a container. The wheel is mounted rotatably on a front end portion of the wheelbarrow frame. The bracket is mounted rotatably on the front end portion of the wheelbarrow frame. The container is mounted on the bracket so as to be co-rotatable therewith and is supported on the wheelbarrow frame.

### BACKGROUND OF THE INVENTION

1. Field of the Invention

The invention relates to a wheelbarrow, more particularly to a wheelbarrow that includes a tiltable container.

2. Description of the Related Art

FIG. 1 illustrates a conventional wheelbarrow 1 that includes a wheelbarrow frame 11, a pair of legs 12, a wheel 13, a container 14, a driving member 16, and a hand lever 17. The wheelbarrow frame 11 has front and rear end portions 111, 112, and an intermediate portion 113 that interconnects the front and rear end portions thereof 111, 112. Each of the legs 12 is mounted to the intermediate portion 113 of the wheelbarrow frame 11 and supports the wheelbarrow frame 11 on the ground. The wheel 13 is mounted rotatably on the front end portion 111 of the wheelbarrow frame 11. The container 14 is mounted on the intermediate portion 113 of the wheelbarrow frame 11. The driving member 16 is mounted on the intermediate portion 113 of the wheelbarrow frame 11, is coupled to the wheel 13, and is operable so as to drive rotation of the wheel 13 when actuated. The hand lever 17 is mounted on the rear end portion 112 of the wheelbarrow frame 11, is coupled to the driving member 16, and is operable so as to actuate the driving member 16.

In operation, with further reference to FIG. 2, when it is desired to transport contents (not shown) of the container 14 from one location to another, the rear end portion 112 of the wheelbarrow frame 11 is first lifted so that each of the legs 12 no longer rests on the ground. When the rear end portion 112 of the wheelbarrow frame 11 is lifted, the wheelbarrow frame 11 rotates about the wheel 13. In this state, the hand lever 17 may be operated to move the conventional wheelbarrow 1. Once a desired location is reached, the contents of the container 14 are unloaded by lifting the rear end portion 112 of the wheelbarrow frame 11 to a height sufficient to remove the contents out from the front of the container 14.

The conventional wheelbarrow 1 is effective, but has numerous drawbacks. For example, since the unloading of the contents of the container 14 requires the operator to manipulate the wheelbarrow frame 11 and the container 14 as discussed above, this may lead to back strain. Additionally, since the conventional wheelbarrow 1 is balanced over the wheel 13 during the transport operation thereof, it becomes difficult for the operator to maneuver the conventional wheelbarrow 1 when an attempt is made to operate the conventional wheelbarrow 1 over rough terrain. Moreover, the operator must maintain the conventional wheelbarrow 1 in balance during such maneuvering over rough terrain. The strains experienced by the operator to perform such maneuvering and balancing may be such that the operator suffers from serious arm injury.

### SUMMARY OF THE INVENTION

Therefore, the main object of the present invention is to provide a wheelbarrow that can overcome the aforesaid drawbacks of the prior art.

According to the present invention, a wheelbarrow comprises a wheelbarrow frame, a wheel, a bracket, and a container. The wheelbarrow frame has opposite front and rear end portions, and an intermediate portion that interconnects the front and rear end portions thereof. The wheel is mounted rotatably on the front end portion of the wheelbarrow frame. The bracket is mounted rotatably on the front end portion of the wheelbarrow frame. The container is mounted on the bracket so as to be co-rotatable therewith, and is supported on the intermediate portion of the wheelbarrow frame.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional wheelbarrow;

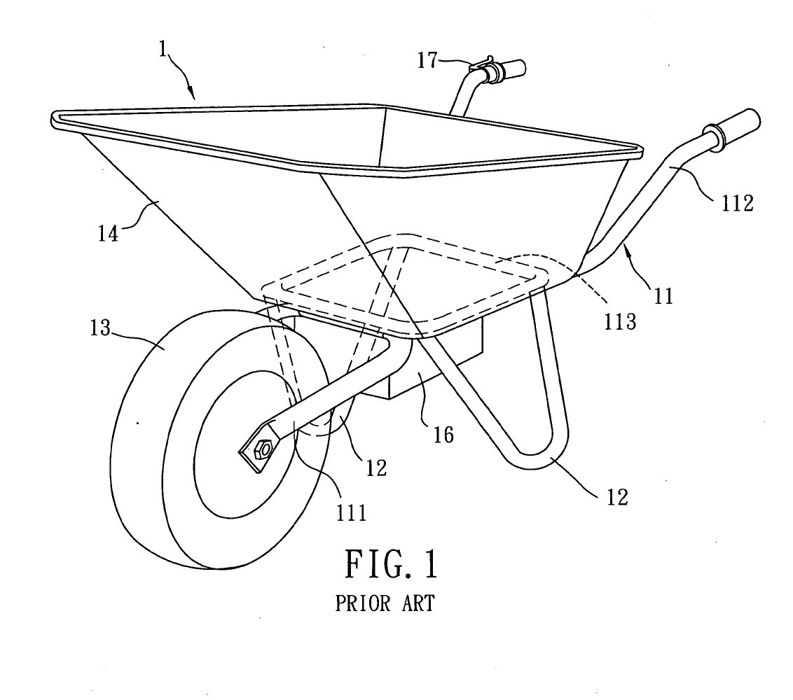

FIG. 2 is a perspective view of the conventional wheelbarrow in a state of use;

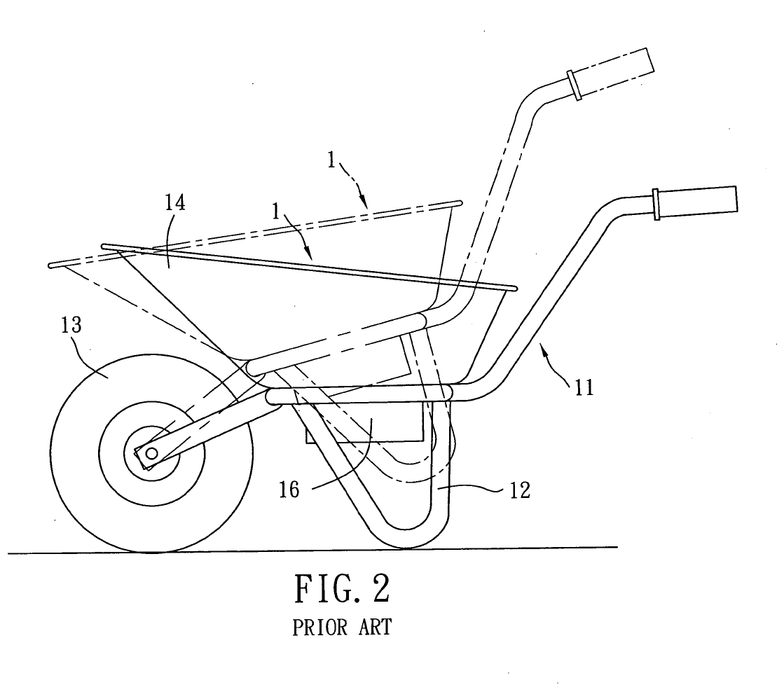

FIG. 3 is a perspective view of the preferred embodiment of a wheelbarrow according to the present invention;

FIG. 4 is a schematic view to illustrate a container of the preferred embodiment in a tilted state;

FIG. 5 is a fragmentary perspective view to illustrate a retaining member of a stand of the preferred embodiment;

FIG. 6 is a sectional view to illustrate the retaining member of the stand of the preferred embodiment in a state of use;

FIG. 7 is a fragmentary perspective view to illustrate a latch of the preferred embodiment; and

FIG. 8 is a schematic view to illustrate a wheel assembly of the preferred embodiment.

### DETAILED DESCRIPTION OF THE PREFERRED EMBODIMENT

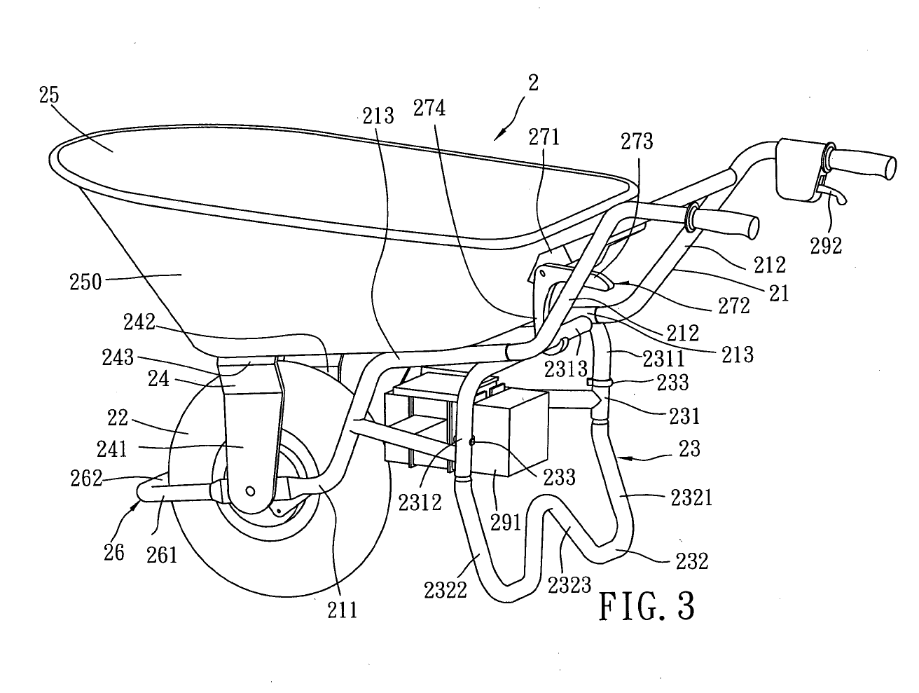

Referring to FIG. 3, the preferred embodiment of a wheelbarrow 2 according to this invention is shown to include a wheelbarrow frame 21, a wheel 22, a bracket 24, and a container 25.

The wheelbarrow 2 of this embodiment is suitable for use either on smooth or rough terrain.

The wheelbarrow frame 21 includes left and right frame parts. In this embodiment, each of the left and right frame parts of the wheelbarrow frame 21 has opposite front and rear end portions 211, 212 (only the front end portion 211 of the left right frame part is shown in FIG. 3), and an intermediate portion 213 that interconnects the front and rear end portions 211, 212 thereof.

The intermediate portion 213 of each of the left and right frame parts of the wheelbarrow frame 21 has a first segment that extends inclinedly and upwardly from the front end portion 211 of the respective one of the left and right frame parts, and a second segment that extends horizontally from the first segment of the intermediate portion 213 of the respective one of the left and right frame parts.

The rear end portion 212 of each of the left and right frame parts of the wheelbarrow frame 21 has a first segment that extends inclinedly and upwardly from the second segment of the intermediate portion 213 of the respective one of the left and right frame parts, and a second segment that extends horizontally from the first segment of the rear end portion 212 of the respective one of the left and right frame parts.

The wheel 22 is disposed between and is mounted on the front end portions 211 of the left and right frame parts of the wheelbarrow frame 21, and defines an axis of rotation.

The bracket 24 is generally U-shaped, and includes first and second bracket members 241, 242, each of which is mounted rotatably on the front end portion 211 of a respective one of the left and right frame parts of the wheelbarrow frame 21, and a third bracket member 243 that interconnects the first and second bracket members 241, 242.

In this embodiment, the bracket 24 is rotatable relative to the wheelbarrow frame 21 about the axis of rotation of the wheel 22 between loading and unloading positions. The bracket 24 undergoes a substantially ninety-degree change in angle between the loading and unloading positions thereof.

The container 25 has a bottom surface 250 that is mounted on the third bracket member 243 of the bracket 24 so as to be co-rotatable therewith.

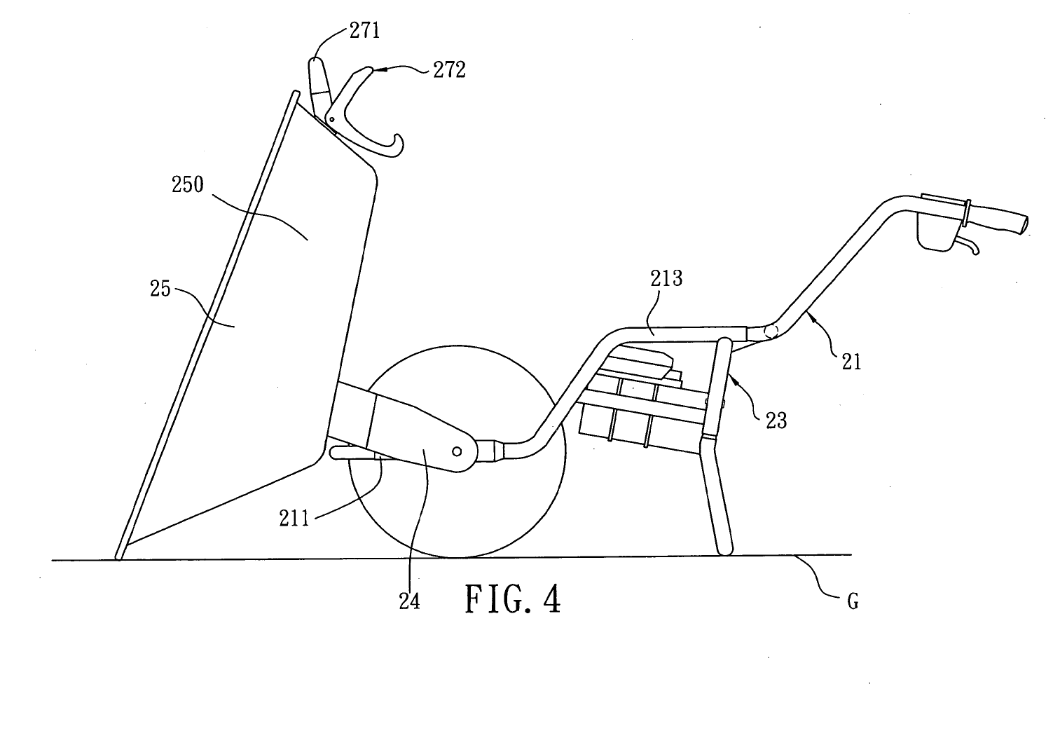

It is noted herein that when the bracket 24 is disposed at the loading position, the bottom surface 250 of the container 25 is supported on the second segments of the intermediate portions 213 of the left and right frame parts of the wheelbarrow frame 21, i.e., the container 25 is disposed at a substantially horizontal position. On the other hand, when the bracket 24 is disposed at the unloading position, the container 25 is disposed at a tilted position, as best shown in FIG. 4.

The wheelbarrow 2 further includes a stand 23 that is mounted to the intermediate portions 213 of the left and right frame parts of the wheelbarrow frame 21 and that supports the wheelbarrow frame 21 on the ground (G), as best shown in FIG. 4.

The wheelbarrow 2 further includes a grip 271 that is provided on a rear end of the bottom surface 250 of the container 25.

The wheelbarrow 2 further includes a driving member 291 and a hand lever 292. In this embodiment, the driving member 291, which includes an engine (not shown), is mounted on the intermediate portions 213 of the left and right frame parts of the wheelbarrow frame 21, is coupled to the wheel 22, and is operable so as to drive rotation of the wheel 22 when actuated. On the other hand, the hand lever 292 is mounted on the rear end portion 212 of the right frame part of the wheelbarrow frame 21, is coupled to the driving member 291, and is operable so as to actuate the driving member 291. Since the construction of each of the driving member 291 and the hand lever 292 is known to those skilled in the art, a detailed description of the same will be dispensed herein for the sake of brevity.

In operation, when it is desired to transport contents (not shown) of the container 25 from one location to another, the rear end portion 212 of the wheelbarrow frame 21 is first lifted so that the stand 23 no longer rests on the ground (G). When the rear end portion 212 of the wheelbarrow frame 21 is lifted, the wheelbarrow frame 21 rotates about the wheel 22. In this state, the hand lever 17 may be operated to move the wheelbarrow 2. Once a desired location is reached, the stand 23 is rested on the ground (G). Thereafter, the container 25 is lifted via the grip 271 until the container 25 is disposed at the tilted position. Hence, the contents are unloaded from the container 25. As the container 25 is lifted, the bracket 24 rotates about the wheel 22.

The wheelbarrow frame 21 further includes a bumper 26. In this embodiment, the bumper 26 is generally U-shaped, and includes first and second bumper members 261 (only the second bumper member 261 is shown in FIG. 3), each of which is mounted on the front end portion 211 of a respective one of the left and right frame parts of the wheelbarrow frame 21, and a third bumper member 262 that interconnects the first and second bumper members 261 and that is disposed in front of the wheel 22.

The stand 23 includes upper and lower members 231, 232. In this embodiment, the upper member 231 of the stand 23 is generally U-shaped, and has first and second segments 2311, 2312, each of which is tubular in shape and extends downwardly, and a third segment 2313 that interconnects the first and second segments 2311, 2312 of the upper member 231 and that is mounted on the intermediate portions 213 of the left and right frame parts of the wheelbarrow frame 21. The lower member 232 of the stand 23 includes first and second segments 2321, 2322, each of which extends removably into a respective one of the first and second segments 2311, 2312 of the upper member 231 of the stand 23, and an inverted V-shaped third segment 2323 that interconnects the first and second segments 2321, 2322 of the lower member 232 of the stand 23.

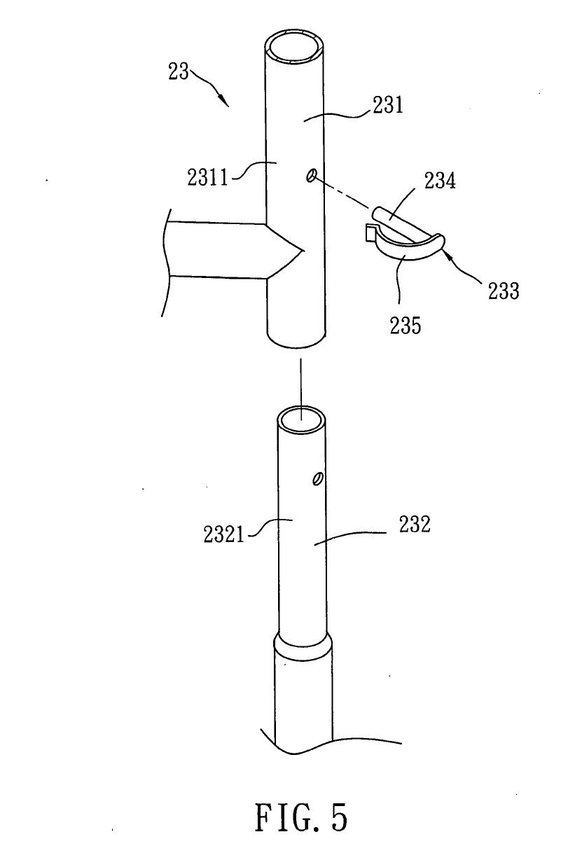

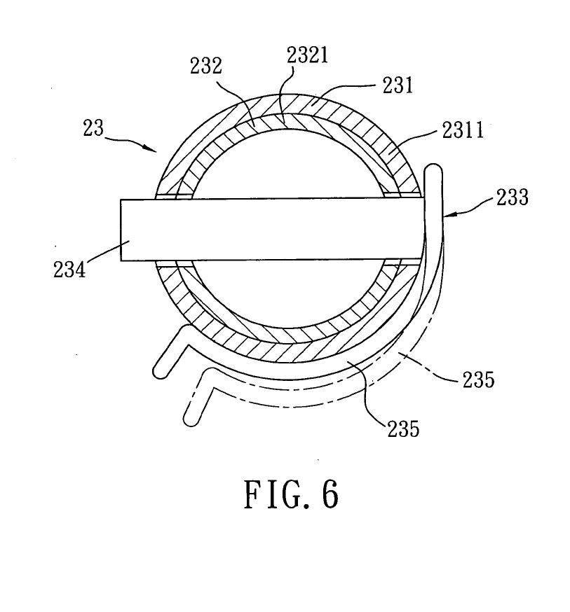

The stand 23 further includes left and right retaining members 233, each of which retains a respective one of the first and second segments 2321, 2322 of the lower member 232 of the stand 23 in a respective one of the first and second segments 2311, 2312 of the upper member 231 of the stand 23. In this embodiment, as best shown in FIGS. 5 and 6, the right retaining member 233 includes a shank 234 that is inserted removably through the first segment 2311 of the upper member 231 of the stand 23 and the first segment 2321 of the lower member 232 of the stand 23, and a resilient clamp 235 that is connected to the shank 234 and that engages resiliently the first segment 2311 of the upper member 231 of the stand 23.

Since the construction and operation of the left retaining member 233 are similar to those of the right retaining member 233, a detailed description thereof is omitted herein for the sake of brevity.

From the above description, when it is desired to detach the lower member 232 of the stand 23 from the upper member 231 of the stand 23, the resilient clamp 235 of each of the left and right retaining members 233 is first disengaged from the respective one of the first and second segments 2311, 2312 of the upper member 231 of the stand 23. Then, the shank 234 of each of the left and right retaining members 233 is pulled out from the respective one of the first and second segments 2311, 2312 of the upper member 231 of the stand 23 and the respective one of the first and second segments 2321, 2322 of the lower member 232 of the stand 23. Thereafter, each of the first and second segments 2321, 2322 of the lower member 23 of the stand 23 is pulled out from the respective one of the first and second segments 2311, 2312 of the upper member 231 of stand 23.

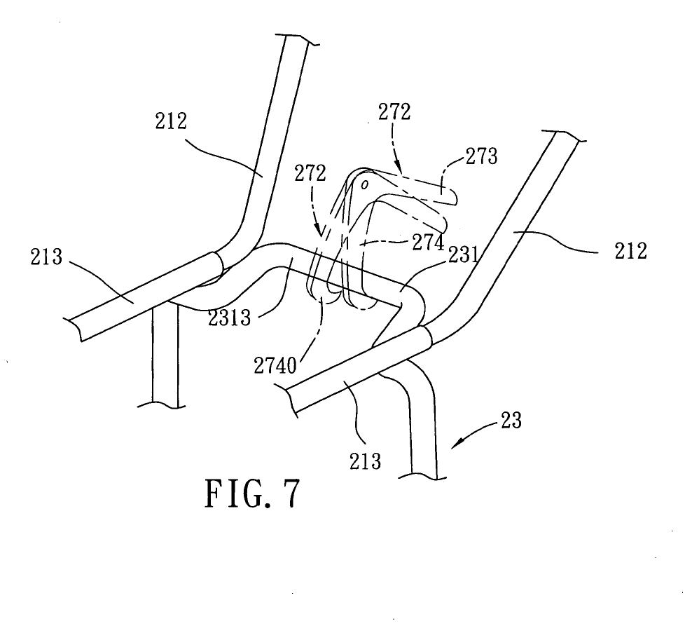

The wheelbarrow 2 further includes a latch 272 for securing the rear end of the bottom surface 250 of the container 25 on the second segments of the intermediate portions 213 of the left and right frame parts of the wheelbarrow frame 21. In particular, with further reference to FIG. 7, the latch 272 has a first end portion 273 that extends away from the container 25 and that is connected pivotably to the grip 271, and a second end portion 274 that extends downwardly from the first end portion 273 and that is provided with a hook 2740. The first end portion 273 of the latch 272 is pivotable relative to the grip 271 between a latching position, where the hook 2740 of the second end portion 274 of the latch 272 engages releasably the third segment 2313 of the upper member 231 of the stand 23, and an unlatching position, where the hook 2740 of the second end portion 274 of the latch 272 disengages the third segment 2313 of the upper member 231 of the stand 23.

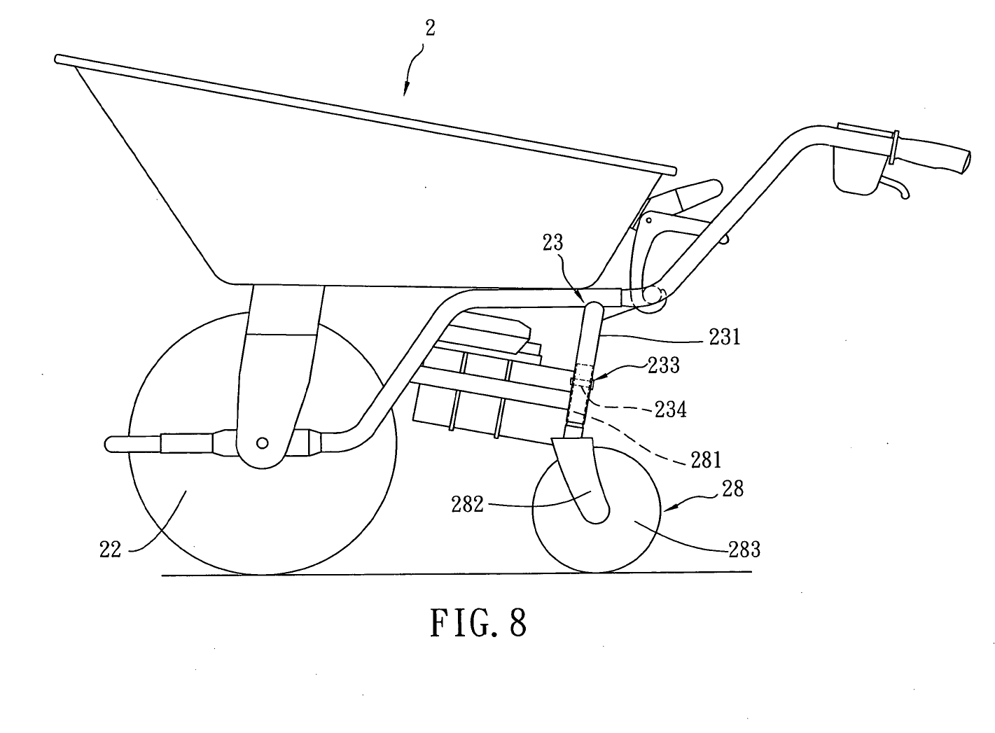

With further reference to FIG. 8, the wheelbarrow 2 further includes a pair of wheel assemblies 28 (only one of the wheel assemblies 28 is shown in FIG. 8). In this embodiment, each of the wheel assemblies 28 includes an inverted U-shaped wheel-supporting member 282, an auxiliary wheel 283 that is mounted rotatably on the wheel-supporting member 282, and a post 281 that is connected to the wheel-supporting member 282 and that is insertable into a respective one of the first and second segments 2311, 2312 of the upper member 231 of the stand 23.

From the above description, when it is desired to improve maneuverability of the wheelbarrow 2 of this invention over rough terrain (not shown), the lower member 232 of the stand 23 may be replaced with the wheel assemblies 28. To perform such replacement, the lower member 232 of stand 23 is first detached from the upper member 231 of the stand 23. Then, the post 281 of each of the wheel assemblies 28 is inserted into a respective one of the first and second segments 2311, 2312 of the upper member 231 of the stand 23. Thereafter, the retaining members 233 are used to retain the post 234 of each of the wheel assemblies 28 in a respective one of the first and second segments 2311, 2312 of the upper member 231 of the stand 23.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A wheelbarrow, comprising:
a wheelbarrow frame having opposite front and rear end portions, and an intermediate portion that interconnects said front and rear end portions thereof;
a wheel mounted rotatably on said front end portion of said wheelbarrow frame;
a bracket mounted rotatably on said front end portion of said wheelbarrow frame; and
a container mounted on said bracket so as to be co-rotatable therewith, and supported on said intermediate portion of said wheelbarrow frame.

2. The wheelbarrow as claimed in claim 1, wherein said bracket is generally U-shaped, and includes first and second bracket members, each of which is mounted rotatably on said front end portion of said wheelbarrow frame, and a third bracket member that interconnects said first and second bracket members, said container being mounted on said third bracket member of said bracket.

3. The wheelbarrow as claimed in claim 1, further comprising a grip provided on said container, and operable so as to lift said container from said intermediate portion of said wheelbarrow frame, thereby resulting in rotation of said bracket.

4. The wheelbarrow as claimed in claim 1, further comprising a stand mounted on said intermediate portion of said wheelbarrow frame and adapted to support said wheelbarrow frame on the ground.

5. The wheelbarrow as claimed in claim 4, wherein said stand includes an upper member that is mounted on said intermediate portion of said wheelbarrow frame, and a lower member that engages detachably said upper member.

6. The wheelbarrow as claimed in claim 5, wherein said upper member of said stand has first and second segments, each of which is tubular in shape, and a third segment that interconnects said first and second segments of said upper member and that is mounted on said intermediate portion of said wheelbarrow frame,
said lower member of said stand having first and second segments, each of which extends removably into a respective one of said first and second segments of said upper member of said stand.

7. The wheelbarrow as claimed in claim 6, wherein said stand further includes a pair of retaining members, each of said retaining members including a shank that is inserted removably through the respective one of said first and second segments of said upper member of the stand and the respective one of said first and second segments of said lower member of said stand, and a resilient clamp that is connected to said shank and that engages resiliently the respective one of said first and second segments of said upper member of said stand.

8. The wheelbarrow as claimed in claim 6, further comprising a pair of wheel assemblies, each of said wheel assemblies including a wheel-supporting member, an auxiliary wheel that is mounted rotatably on said wheel-supporting member, and a post that is connected to said wheel-supporting member, and that is insertable into a respective one of said first and second segments of said upper member of said stand.

9. The wheelbarrow as claimed in claim 4, further comprising a latch coupled pivotably to said container, said latch being pivotable relative to said container between a latching position, where said latch engages releasably said stand, and an unlatching position, where said latch disengages said stand.

10. The wheelbarrow as claimed in claim 1, further comprising a bumper including first and second bumper members, each of which is mounted on said front end portion of said wheelbarrow frame, and a third bumper member that interconnects said first and second bumper members.

11. The wheelbarrow as claimed in claim 1, further comprising
a driving member mounted on said wheelbarrow frame, coupled to said wheel, and operable so as to drive rotation of said wheel when actuated, and
a hand lever mounted on said rear end portion of said wheelbarrow frame, coupled to said driving member, and operable so as to actuate said driving member.
